(19) United States
(12) Patent Application Publication
(10) Pub. No.: US 2016/0147119 A1
(43) Pub. Date: May 26, 2016

(54) LIQUID CRYSTAL DISPLAY

(71) Applicant: Samsung Display Co., Ltd., Yongin-city (KR)

(72) Inventors: Hak Sun CHANG, Yongin-si (KR); Cheol Shin, Hwaseong-si (KR); Ka Eun Kim, Yongin-si (KR); Ki Chul Shin, Seongnam-si (KR); Se Hyun Lee, Seoul (KR)

(21) Appl. No.: 14/750,599

(22) Filed: Jun. 25, 2015

(30) Foreign Application Priority Data
Nov. 21, 2014 (KR) 10-2014-0163586

(51) Int. Cl. G02F 1/1343

(52) U.S. Cl. CPC G02F 1/134309; G02F 2001/134345

(57) ABSTRACT

A liquid crystal display (LCD) is provided. A liquid crystal display (LCD) comprising a first pixel electrode portion; a second pixel electrode portion disposed adjacent to the first pixel electrode portion in a first direction; and a first data line, extending substantially in a second direction, configured to apply a data voltage to the first pixel electrode portion; wherein the data line comprises a first line portion overlapping the first pixel electrode portion and a second line portion overlapping the second pixel electrode portion.

### CROSS-REFERENCE TO RELATED APPLICATION

This application claims priority from and the benefit of Korean Patent Application No. 10-2014-0163586, filed on Nov. 21, 2014 which is hereby incorporated by reference for all purposes as if fully set forth herein.

### BACKGROUND

1. Field

Exemplary embodiments relates to a liquid crystal display (LCD).

2. Discussion

Liquid crystal displays (LCDs) are a type of flat panel display. From a high-level perspective, an LCD includes a pair of substrates, having electric field generating electrodes such as pixel electrodes and a common electrode, and a liquid crystal layer interposed between the substrates. To display an image on the LCD, voltages are applied to the electric field generating electrodes in the LCD to generate an electric field in the liquid crystal layer, which determines the alignment of liquid crystal molecules of the liquid crystal layer and controls the polarization of incident light.

If an electric field in one direction is applied to the liquid crystal layer for a long time, problems such as degradation or flickering may arise. To prevent or reduce the problems, the LCD can invert the polarity of a driving data voltage (with respect to a common voltage), for portions of the display, such as particular frames, rows, columns, or pixels. An example of such inversion driving is a 2-dot inversion driving method in which two pixels form an inversion unit, where pixels in an odd-numbered row and a pixels in an even-numbered row of the same column are driven with a data voltage of the same polarity.

Because pixels neighboring an inversion unit can be driven with a driving voltage of an opposite polarity when driving a frame, signals of different polarities can be applied on both sides of a data line for an inversion unit, such as a group of two rows in a 2-dot inversion driving. Here, a distance between the data line and each of pixel electrodes in first and second rows may be different from a distance between the data line and each of pixel electrodes in third and fourth rows. Although the distance between the data line and each pixel electrode should be equal, it may be different due to occurrence of a misalignment. Such a relative difference in distance between the data line and pixel electrodes in different inversion units may lead to a difference in parasitic capacitance (Cdp) between each pixel electrode and the data line, causing a horizontal line defect which may degrade display quality.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal display (LCD) without a horizontal line defect caused by a difference in parasitic capacitance (Cdp).

Additional aspects will be set forth in the detailed description which follows, and, in part, will be apparent from the disclosure, or may be learned by practice of the inventive concept.

According to one or more exemplary embodiments, there is provided a liquid crystal display (LCD) comprising a first pixel electrode portion; a second pixel electrode portion disposed adjacent to the first pixel electrode portion in a first direction; and a first data line, extending substantially in a second direction, configured to apply a data voltage to the first pixel electrode portion; wherein the data line comprises a first line portion overlapping the first pixel electrode portion and a second line portion overlapping the second pixel electrode portion.

According to one or more exemplary embodiments, there is provided an LCD comprising

a first pixel electrode portion; a first data line, extending substantially in a first direction, configured to apply a data voltage to the first pixel electrode portion; and a second data line, extending substantially in a first direction, disposed adjacent to the first data line in a second direction, wherein a portion of the first data line overlaps the first pixel electrode portion along a side area of the first pixel electrode portion, and a portion of the second data line overlaps the first pixel electrode along an opposite side area of the first pixel electrode.

According to one or more exemplary embodiments, there is provided an LCD comprising a first pixel electrode portion, a second electrode portion disposed adjacent to the first pixel electrode along a first direction and a first data line extending along a second direction substantially perpendicular to the first direction, wherein the first data line overlaps the first pixel electrode portion and the second pixel electrode portion.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic plan view of a liquid crystal display (LCD) according to one or more exemplary embodiments.

FIG. 2 is an enlarged view schematically illustrating the relationship between pixel electrodes and data lines according to one or more exemplary embodiments.

FIGS. 3 and 4 are cross-sectional views of the LCD taken along the line A-A′ of FIG. 2.

FIGS. 5 and 6 are cross-sectional views of the LCD taken along the line B-B′ of FIG. 2.

FIGS. 7 and 8 are cross-sectional views of a data line of a conventional LCD and pixel electrodes neighboring the data line.

FIG. 9 is a plan view of a pixel of an LCD according to one or more exemplary embodiments.

FIG. 10 is a schematic plan view of an LCD according to one or more exemplary embodiments.

FIG. 11 is an enlarged view schematically illustrating the relationship between pixel electrodes and data lines according to one or more exemplary embodiments.

FIGS. 12 and 13 are cross-sectional views of the LCD taken along the line A-A′ of FIG. 11.

FIGS. 14 and 15 are cross-sectional views of the LCD taken along the line B-B′ of FIG. 11.

FIG. 16 is a plan view of a pixel of an LCD according to one or more embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of components, etc., may be exaggerated for clarity and descriptive purposes. Also, like reference numerals denote like elements.

When a component is referred to as being “on,” “connected to,” or “coupled to” another component, it may be directly on, connected to, or coupled to the other component or intervening components may be present. When, however, a component is referred to as being “directly on,” “directly connected to,” or “directly coupled to” another component, there are no intervening components present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various features, these features should not be limited by these terms. These terms are used to distinguish one feature from another. Thus, a first feature could be termed a second feature without departing from the teachings of the present disclosure.

Spatially relative terms, such as “beneath,” “below,” “lower,” “above,” “upper,” and the like, may be used herein for descriptive purposes, and, thereby, to describe one feature's relationship to another feature as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

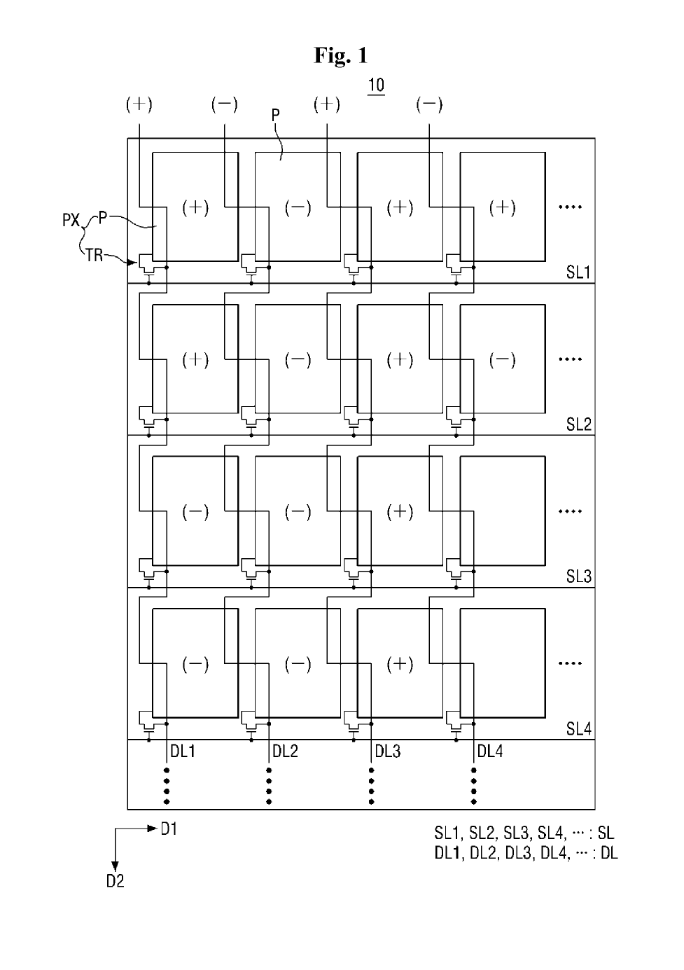

FIG. 1 is a schematic plan view of a liquid crystal display (LCD) 10 according to one or more exemplary embodiments.

Referring to FIG. 1, LCD 10 may include a plurality of pixels PX, a plurality of data lines (DL1, DL2, DL3, etc.) and a plurality of scan lines (SL1, SL2, SL3, etc.). Pixels PX may be arranged in a matrix. Each of the data lines and each of the scan lines may define one pixel PX and may be connected to one pixel PX. Each of pixels PX may include at least one transistor TR and a pixel electrode P. Transistor TR of each pixel PX may have a gate electrode connected to one scan line, a first electrode connected to one data line, and a second electrode connected to the pixel electrode P. Transistor TR of each pixel PX may be turned on by a scan signal received from a scan line to provide a data voltage received from a connected data line to the pixel electrode P. LCD 10 may be driven using a 2-dot inversion method. That is, a pair of upper and lower pixels may form one inversion unit. In a current frame, pixels included in the same inversion unit may receive data voltages of the same polarity. Neighboring pixels on both sides of one inversion unit, on both sides of one data line, may receive data voltages of different polarities.

Scan lines may extend along a first direction D1, parallel to each other. Scan lines may sequentially provide a scan signal to transistor TR of each pixel PX.

Data lines may intersect the scan lines. A data voltage may be provided to each of data lines. The data voltage may be provided to pixel electrode P via turned-on transistor TR. Data lines may have a zigzag shape. Accordingly, data lines may, overall, extend along a second direction D2 perpendicular to the first direction D1. Here, the first direction D1 may be a row direction and the second direction D2 may be a column direction. Data lines DL may be bent repeatedly. In exemplary embodiments, vertical portions in a first direction (in a direction D2) are provided on alternate sides of a virtual line along the first direction and portions in a second direction (in a direction D1) connect the alternating portions. For example, each of data lines DL1, DL2, DL3, etc. may include lines extending on different vertical lines along the second direction D2 and lines extending along the first direction D1 which are connected to each other as illustrated in FIG. 1.

A data line which supplies a data voltage to pixel PX is defined as a self-data line, and a pixel electrode which receives a data voltage of a data line is defined as a self-pixel electrode. Each pixel PX may partially overlap the self-data line and overlap a data line disposed side by side with the self-data line along first direction D1. More specifically, pixel electrode P of each pixel PX may overlap the self-data line and a neighboring data line. Pixel electrode P may include a first side along the first direction D1 and a second side along the second direction D2. Here, pixel electrode P may overlap the self-data line by a length corresponding to substantially half of the second side. Pixel electrode P may overlap an immediately neighboring data line by a length corresponding to substantially the other half of the second side.

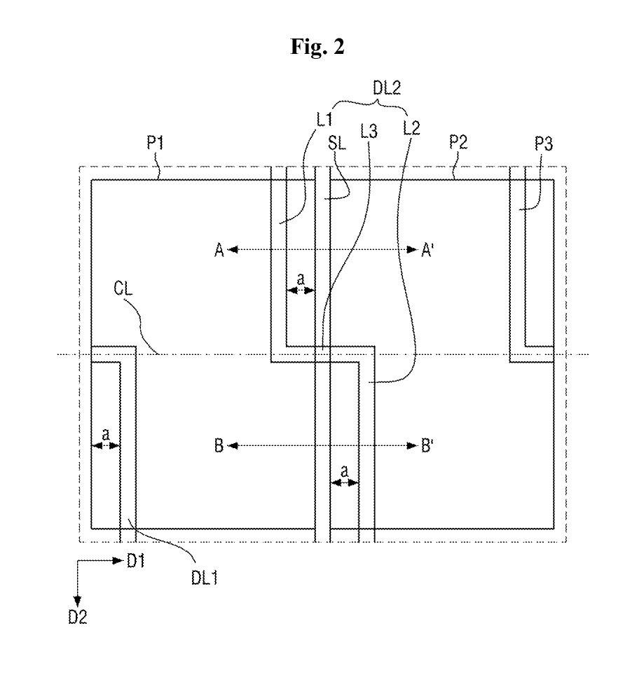

From the perspective of a data line, a single data line may overlap all neighboring pixel electrodes in two columns of pixels. For example, the data line may overlap a pixel electrode disposed on one side thereof and a pixel electrode disposed on the other side thereof. The positional relationship between pixel electrodes and a data line will now be described in greater detail with reference to FIG. 2.

FIG. 2 is an enlarged view schematically illustrating the relationship between pixel electrodes and data lines according to one or more exemplary embodiments.

Referring to FIG. 2, first pixel electrode P1 and second pixel electrode P2 may be arranged side by side along the first direction D1. Second pixel electrode P2 may receive a data voltage from second data line DL2. Second data line DL2 may be a self-data line of pixel PX which includes second pixel electrode P2. Here, data voltages of different polarities may be applied to first pixel electrode P1 and second pixel electrode P2. In one frame, second pixel electrode P2 may receive a data voltage of a negative polarity through second data line DL2, and first pixel electrode P1 may receive a data voltage of a positive polarity through first data line DL1.

Second data line DL2 may include first line L1 which overlaps first pixel electrode P1 and second line L2 which overlaps second pixel electrode P2. Second data line DL2 may further include third line L3 which connects first line L1 and second line L2. First line L1 and second line L2 may extend along second direction D2, and third line L3 may extend along first direction D1. Each of first pixel electrode P1 and second pixel electrode P2 may include a first side corresponding to first direction D1 and a second side corresponding to second direction D2. In addition, each of first pixel electrode P1 and the second pixel electrode P2 may be bisected by a virtual line CL that traverses a center thereof along first direction D1. First line L1 may overlap an upper part of bisected first pixel electrode P1, and second line L2 may overlap a lower part of bisected second pixel electrode P2. However, aspects of the present invention are not limited thereto. In exemplary embodiments, first line L1 may overlap a lower part of first pixel electrode P1, and second line L2 may overlap an upper part of second pixel electrode P1.

Second data line DL2 overlaps each of pixel electrodes P1 and P2. Storage line SL may be disposed in a boundary area between the first pixel electrode P1 and the second pixel electrode P2, which will be described in greater detail below.

From the perspective of a pixel electrode, an upper electrode of first pixel electrode P1 may overlap first line L1 of second data line DL2, and a lower electrode of first pixel electrode P1 may overlap second line L2 of first data line DL1. In addition, an upper electrode of second pixel electrode P2 may overlap first line L1 of third data line DL3, and a lower electrode of second pixel electrode P2 may overlap second line L2 of second data line DL2. One pixel electrode may form parasitic capacitance Cdp of a specific level together with each of a self-data line and an immediately neighboring data line. One pixel electrode may form the parasitic capacitance Cdp together with each data line that it overlaps. Here, one pixel electrode may form the parasitic capacitance Cdp together with each of diagonally symmetrical data lines having different polarities. Accordingly, the parasitic capacitance Cdp generated in one pixel electrode can be minimized.

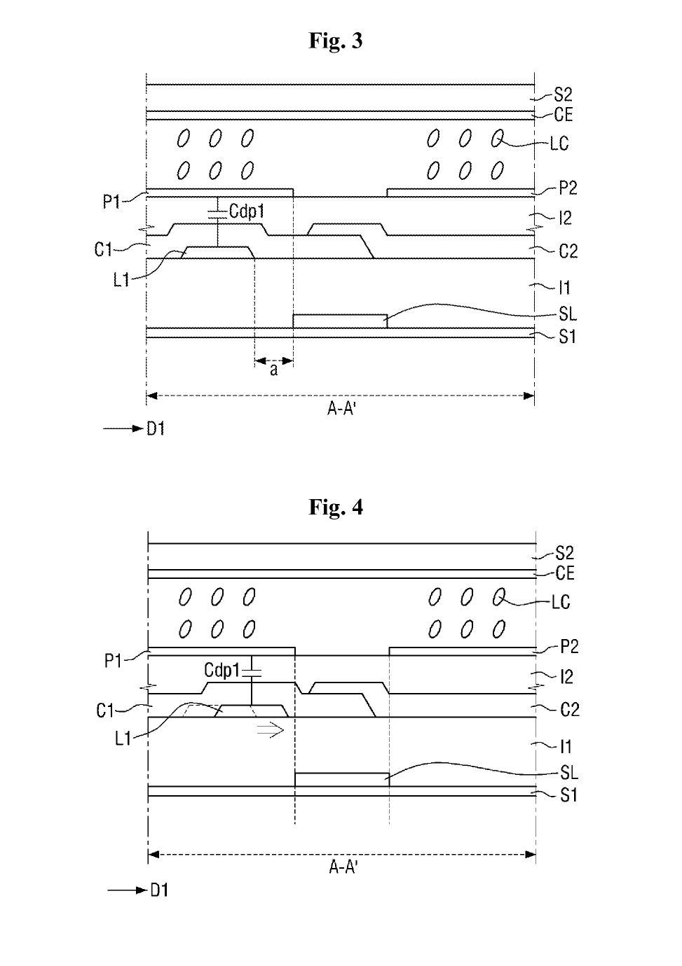

Each of first line L1 and second line L2 may be separated by a predetermined distance “a” from the boundary area between first pixel electrode P1 and second pixel electrode P2. First line L1 may be separated from the boundary area between first pixel electrode P1 and second pixel electrode P2 by the predetermined distance a to overlap first pixel electrode P1. Second line L2 may be separated from the boundary area between first pixel electrode P1 and second pixel electrode P2 by the predetermined distance a to overlap second pixel electrode P2. Here, the predetermined distance a may be a distance at which first line L1 does not form the parasitic capacitance Cdp with second pixel electrode P2 and at which second line L2 does not form the parasitic capacitance Cdp with first pixel electrode P1. The predetermined distance “a” may be a maximum error distance set in view of the possible misalignment of a data line. Even if second data line DL2 is misaligned, entire first line L1 may still overlap first pixel electrode P1. The effects of the data line structure according to one or more exemplary embodiments will now be described in greater detail with reference to FIGS. 3 through 6.

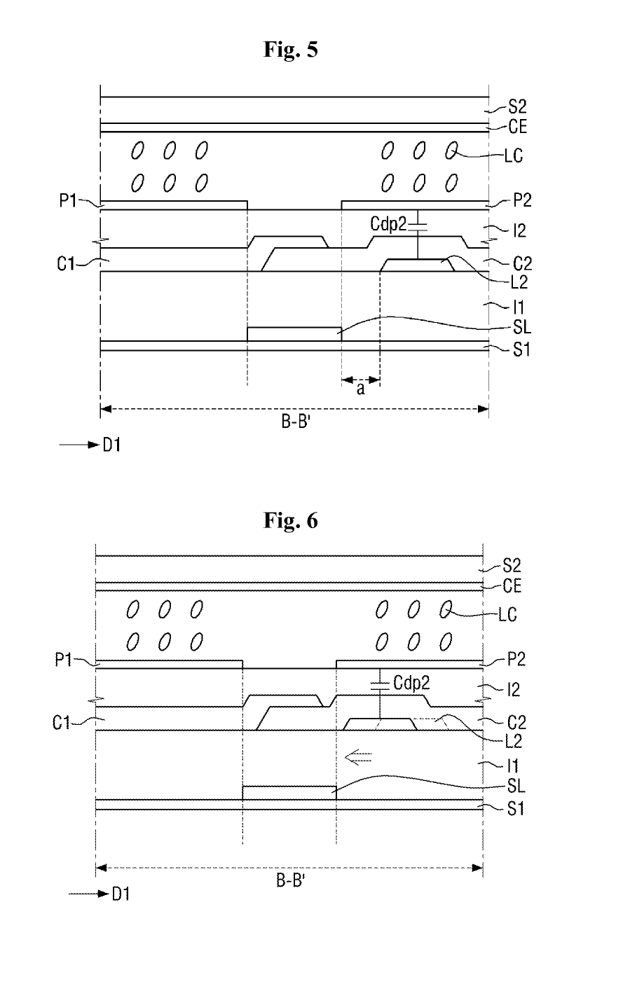

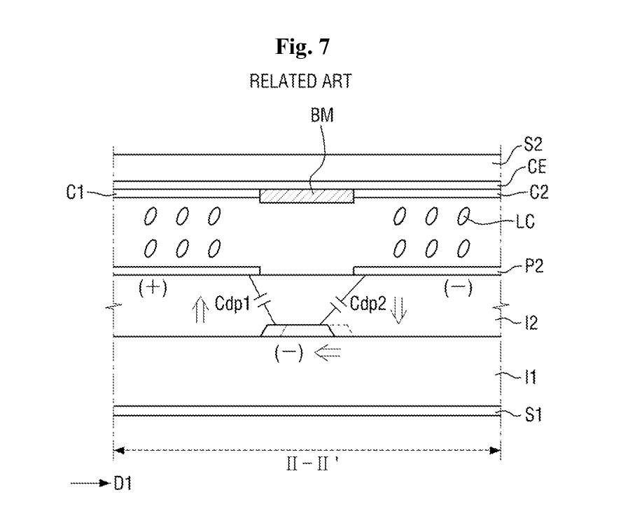

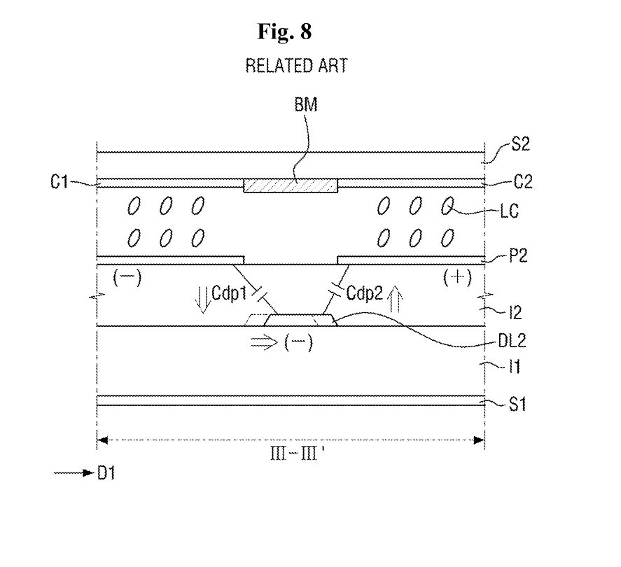

FIGS. 3 and 4 are cross-sectional views of the LCD 10 taken along the line A-A′ of FIG. 2. FIGS. 5 and 6 are cross-sectional views of the LCD 10 taken along the line B-B′ of FIG. 2. FIGS. 7 and 8 are cross-sectional views of a data line of a conventional LCD and pixel electrodes neighboring the data line.

Referring to FIGS. 7 and 8, a data line of the conventional LCD may be disposed to correspond to a boundary area between neighboring pixel electrodes. Therefore, the data line may form parasitic capacitance with each of the pixel electrodes disposed on both sides thereof. Here, a process error can cause the data line to be misaligned, that is, shifted in the first direction D1 or a reverse direction of the first direction D1, thereby changing the parasitic capacitance. Generally, parasitic capacitance is inversely proportional to a distance between a data line and a pixel electrode. Therefore, as the data line is shifted, the magnitude of the parasitic capacitance formed by the data line and each of the pixel electrodes on both sides of the data line may be changed. Since the level of a voltage applied to a pixel electrode varies according to the parasitic capacitance, a gray level different from a preset gray level may be expressed. In the 2-dot inversion method, if pixel electrodes corresponding to a boundary between different inversion units are shifted in different directions as illustrated in FIGS. 7 and 8, a horizontal line defect in which a boundary between the pixel electrodes is visible may occur.

Referring to FIGS. 3 through 6, LCD 10 according to one or more exemplary embodiments may further include first substrate S1, first insulating layer I1, storage line SL, first color filter C1, second color filter C2, second insulating layer I2, liquid crystal layer LC, common electrode CE, and second substrate S2.

First substrate S1 may be an insulating substrate, on which the pixel electrodes P1 and P2 are formed or disposed. Second substrate S2 may face first substrate S1 and may be a substrate on which the common electrode CE is formed or disposed. Pixel electrodes P1 and P2 and common electrode CE may form a vertical electric field. However, aspects of the present invention are not limited thereto, and common electrode CE can also be formed or disposed on the same layer as or a different layer from pixel electrodes P1 and P2 on first substrate S1 to form a horizontal electric field. The arrangement of liquid crystals included in liquid crystal layer LC between first substrate S1 and second substrate S2 may change according to an electric field formed by pixel electrodes P1 and P2 and common electrode CE. Here, data voltages may be applied to first and second pixel electrodes P1 and P2 via first data line DL1 and second data line DL2 as described above, and a specific common voltage may be applied to common electrode CE. A backlight (not illustrated) may be disposed under first substrate S1 and emit light in an upward direction. The arrangement of the liquid crystals in liquid crystal layer LC may vary according to a difference between the common voltage and a data voltage. That is, the luminance of backlight that passes through liquid crystal layer LC may be controlled by a change in the arrangement of the liquid crystals in liquid crystal layer LC.

A scan line (not illustrated) and storage line SL may be formed or disposed on the first substrate S1. Storage line SL may provide a specific voltage to each storage electrode which forms an electric field with a pixel electrode. The storage electrode (not illustrated) may overlap edges of each pixel electrode, but aspects of the present invention are not limited thereto. Storage line SL may be formed to correspond to a boundary between pixel electrodes. That is, storage line SL may have a cross-sectional area corresponding to a gap between the pixel electrodes. A width of storage line SL may be substantially equal to the distance between the boundaries of first pixel electrode P1 and second pixel electrode P2. Since storage line SL is disposed to correspond to the boundary between the first pixel electrode P1 and the second pixel electrode P2, the leakage of light which may occur when no data line passes through the boundary between the first pixel electrode P1 and the second pixel electrode P2 may be prevented or reduced.

First insulating layer I1 may be formed or disposed on first substrate S1, the scan line (not illustrated), and storage line SL. First insulating layer I1 may be a gate insulating layer and may electrically insulate the scan line (not illustrated) and storage line SL from components formed or disposed on first insulating layer I1.

A data line may be formed or disposed on first insulating layer I1. For example, first line L1 may be formed or disposed on first insulating layer I1. Color filters C1 and C2 may be formed on first line L1 and first insulating layer I1. In LCD 10 according to one or more exemplary embodiments, color filters C1 and C2 may be formed or disposed on first substrate S1. First color filter C1 may be formed or disposed to correspond to first pixel electrode P1. First color filter C1 may include one of red, green, and blue colors. Second color filter C2 may be formed or disposed to correspond to second pixel electrode P2 neighboring first pixel electrode P1. Second color filter C2 may produce a different color from first color filter C1. First color filter C1 and second color filter C2 may overlap each other between first pixel electrode P1 and second pixel electrode P2. By placing color filters C1 and C2 on lower substrate S1, the leakage of light caused when no data line overlaps the boundary between the first pixel electrode P1 and the second pixel electrode P2 may be prevented or reduced. LCD 10 according to one or more exemplary embodiments may not require a black matrix because storage line SL and color filters C1 and C2 are formed or disposed at the boundary between first pixel electrode P1 and second pixel electrode P2. Accordingly, the overall thickness of LCD 10 can be reduced. Second insulating layer I2 may be formed or disposed on color filters C1 and C2 and may be a planarization layer. Pixel electrodes P1 and P2 may be formed or disposed on second insulating layer I2.

First line L1 may overlap first pixel electrode P1. First line L1 may be separated by a predetermined distance “a” from the boundary between first pixel electrode P1 and second pixel electrode P2. The predetermined distance “a” may be a distance at which first line L1 does not form parasitic capacitance with second pixel electrode P2. First line L1 may form parasitic capacitance Cdp1 only with first pixel electrode P1. For example, first pixel electrode P1 may form parasitic capacitance with first line L1 of second data line DL2 and may form parasitic capacitance with second line L2 of first data line DU. The predetermined distance “a” may be a maximum error distance set in view of the possible misalignment of a data line. Even if second data line DL2 is misaligned along first direction D1, entire first line L1 may still overlap first pixel electrode P1. Referring to FIG. 4, even if first line L1 is misaligned, such as being shifted to such that the distance between the edge of line L1 and the edge of the first pixel electrode in the first direction D1 is less than distance a, line L1 still overlaps the first pixel electrode P1. Since the entire first line L1 still overlaps first pixel electrode P1, a distance in the vertical direction between first line L1 and first pixel electrode P1 may be maintained at a constant distance despite misalignment. Therefore, first line L1 may still form the parasitic capacitance Cdp1 only with first pixel electrode P1. Accordingly, the parasitic capacitance Cdp1 between first line L1 and first pixel electrode P1 may not substantially change.

Likewise, second line L2 may overlap second pixel electrode P2 and may be separated by a predetermined distance “a” from the boundary between first pixel electrode P1 and second pixel electrode P2. The predetermined distance “a” may be a distance at which second line L2 does not form parasitic capacitance with first pixel electrode P1. Second line L2 may form parasitic capacitance Cdp2 only with second pixel electrode P2. The predetermined distance “a” may be a maximum error distance set in view of the possible misalignment of a data line. Even if second data line DL2 is misaligned along, e.g., the reverse direction of first direction D1, the entire second line L2 may still overlap second pixel electrode P2. Referring to FIG. 6, even if second line L2 is misaligned, by being shifted in the reverse direction of the first direction D1, it may still overlap the second pixel electrode P2. Since the entire second line L2 still overlaps second pixel electrode P2, a vertical distance between second line L2 and second pixel electrode P2 may be maintained at a constant distance despite misalignment. Therefore, second line L2 may still form the parasitic capacitance Cdp2 only with second pixel electrode P1. Accordingly, parasitic capacitance Cdp2 between second line L2 and second pixel electrode P2 may not substantially change. Even from the perspective of a pixel electrode, a voltage level of the pixel electrode may not change despite the misalignment of a data line.

Parasitic capacitance formed by a pixel electrode and a data line according to one or more exemplary embodiments may have a constant value despite the misalignment of the data line. Accordingly, even if the 2-dot inversion method is used, there may be no substantial change in the parasitic capacitance in an inversion unit. This may prevent or reduce a horizontal line defect, thus providing a more improved display quality.

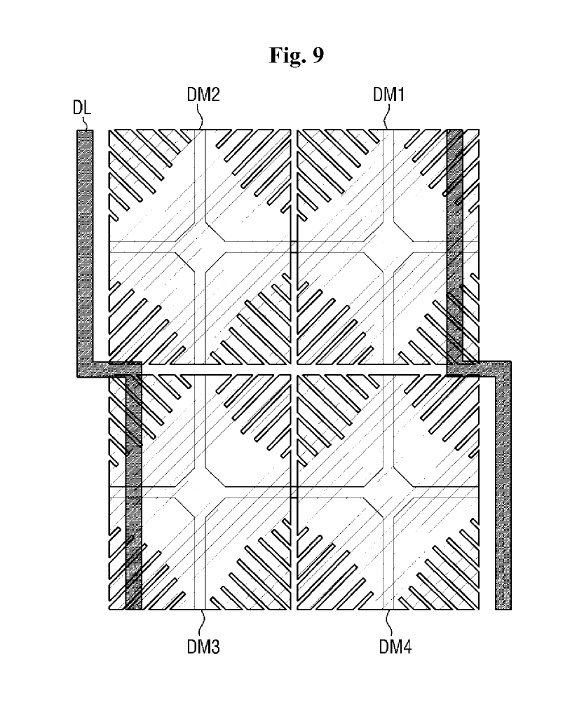

FIG. 9 is a plan view of a pixel of an LCD according to one or more exemplary embodiments.

Referring to FIG. 9, the pixel of the LCD according to the exemplary embodiments may be divided into a plurality of domains. The domains may be four domains, and liquid crystals in the domains may rotate in a counterclockwise direction, but aspects of the present invention are not limited thereto. Third line L3 of one data line may pass through a boundary area between domains. In addition, first line L1 of one data line and second line L2 of another data line immediately neighboring the data line may overlap domains that are diagonally symmetrical to each other. This may reduce or minimize a change in a domain ratio due to an overlap between a data line and a pixel electrode.

Each pixel electrode according to one or more exemplary embodiments may include a first subpixel electrode and a second subpixel electrode. Different voltages may be applied to the first subpixel electrode and the second subpixel electrode in order to improve a viewing angle, and the first subpixel electrode and the second subpixel electrode may display one image. A self-data line of each pixel electrode may overlap a half of the first subpixel electrode and a half of the second subpixel electrode. In addition, a data line immediately neighboring the pixel electrode may overlap the other half of the first subpixel electrode and the other half of the subpixel electrode. The data line structure of one or more exemplary embodiments may also be applied to the LCD driven using the first subpixel electrode and the second subpixel electrode.

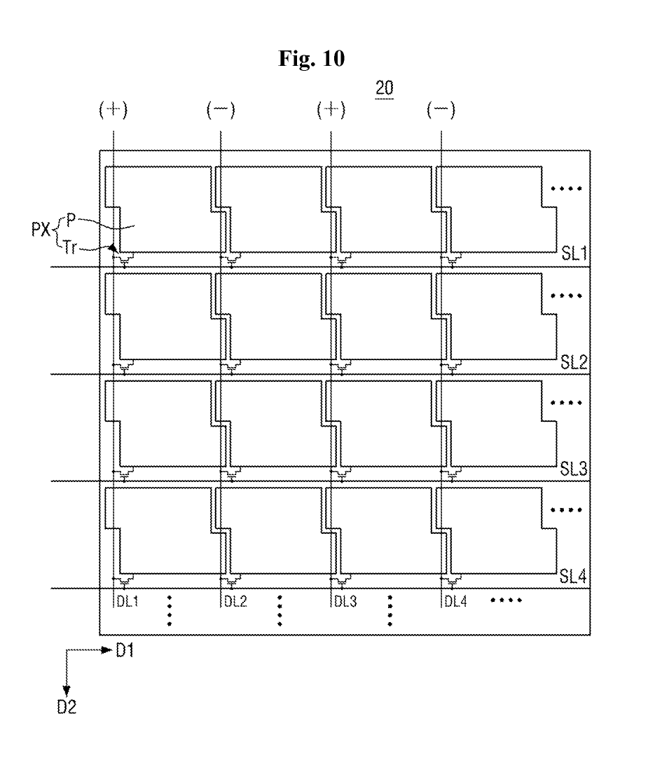

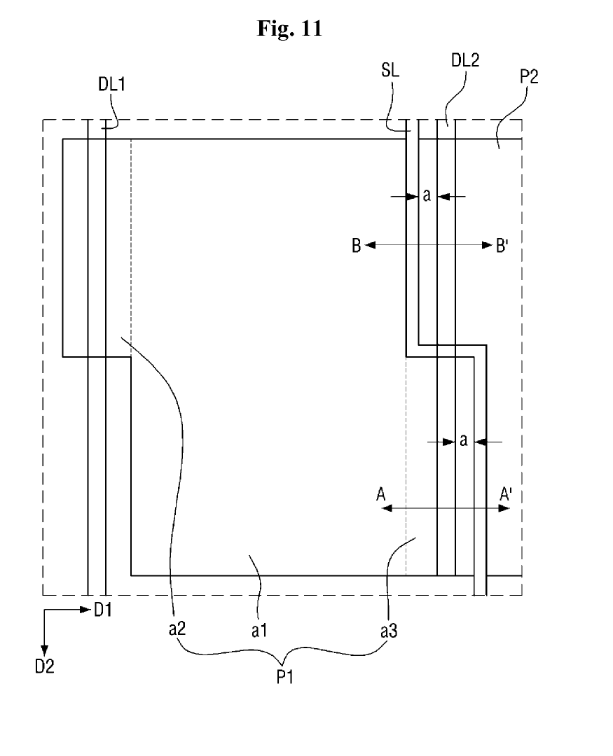

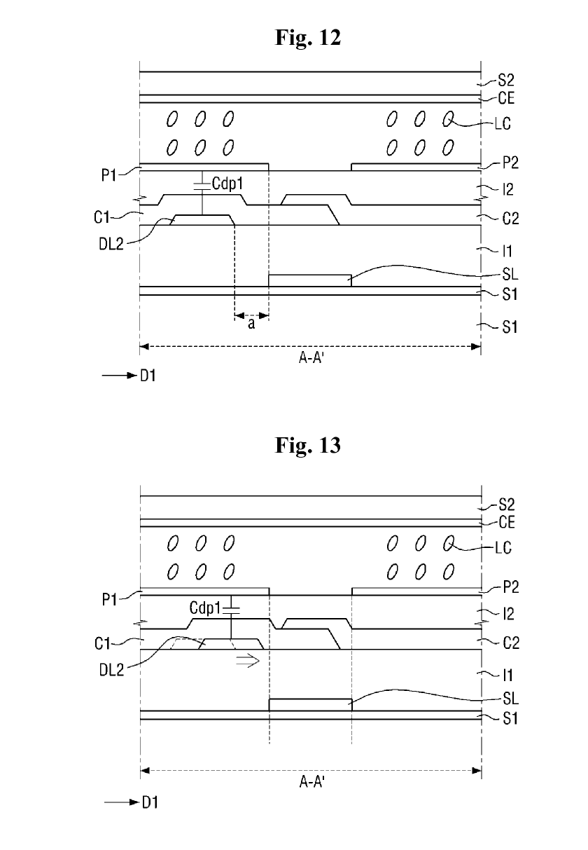

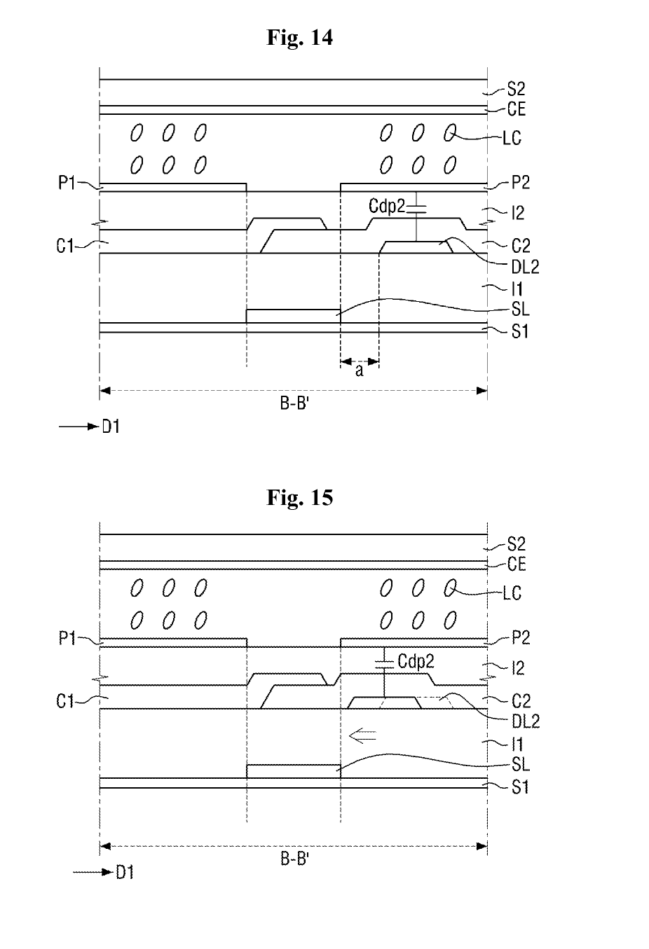

FIG. 10 is a schematic plan view of LCD 20 according to one or more exemplary embodiments. FIG. 11 is an enlarged view schematically illustrating the relationship between pixel electrodes and data lines according to one or more exemplary embodiments. FIGS. 12 and 13 are cross-sectional views of the LCD 20 taken along the line A-A′ of FIG. 11. FIGS. 14 and 15 are cross-sectional views of the LCD 20 taken along the line B-B′ of FIG. 11.

Referring to FIGS. 10 through 15, LCD 20 may include a plurality of pixels PX, a plurality of data lines (DL1, DL2, DL3, etc.), and a plurality of scan lines (SL1, SL2, SL3, etc.). Pixels PX may be arranged in a matrix. Each of data lines and each of scan lines may define one pixel PX and may be connected to one pixel PX. Each of pixels PX may include at least one transistor TR and pixel electrode P. Transistor TR of each pixel PX may have a gate electrode connected to one scan line, a first electrode connected to one data line, and a second electrode connected to pixel electrode P. Transistor TR of each pixel PX may be turned on by a scan signal received from a scan line to provide a data voltage received from a connected data line to pixel electrode P. LCD 20 may be driven using a 2-dot inversion method in which a pair of upper and lower pixels may form one inversion unit.

Scan lines may extend along first direction D1. Scan lines may extend parallel to each other. Scan lines may sequentially provide a scan signal to transistor TR of each pixel PX.

Data lines may intersect scan lines and may extend along second direction D2 perpendicular to first direction D1. A data voltage may be provided to each of the data lines.

One data line may overlap specific areas of neighboring pixels. Referring to FIG. 11, second data line DL2 may overlap two neighboring pixel electrodes P1 and P2. For example, second data line DL2 may overlap first pixel electrode P1 and second pixel electrode P2. Here, second data line DL2 may be a data line to which a data voltage to be provided to second pixel electrode P2 is applied. Each pixel electrode may include first area a1, second area a2 protruding from a first side of first area a1, and third area a3 protruding from a second side of first area a1. Second area a2 and third area a3 may not overlap along first direction D1. Second area a2 and third area a3 may protrude in opposite directions. Second area a2 and third area a3 may respectively protrude from respective halves of the first and second sides of first area a1. Second area a2 and third area a3 may have substantially an equal width. In an exemplary embodiment, pixel electrode P may be shaped such that pixel electrode P is bisected along first direction D1 and that each area of bisected pixel electrode P is shifted.

First pixel electrode P1 and second pixel electrode P2 may be arranged side by side along first direction D1. Third area a3 of first pixel electrode P1 may be formed or disposed adjacent to a non-protruding part of the first side of first area a1 of the second pixel electrode P2. In addition, second area a2 of second pixel electrode P2 may be disposed adjacent to a non-iii protruding part of the second side of first area a1 of first pixel electrode P1. A boundary area between first pixel electrode P1 and second pixel electrode P2 may have a zigzag shape, in which the boundary between the first pixel electrode P1 and the second pixel electrode P2 may be bent repeatedly. Second data line DL2 may overlap third area a3 of first pixel electrode P1 and second area a2 of second pixel electrode P2. Second data line DL2 may not be formed or disposed along the boundary area between first pixel electrode P1 and second pixel electrode P2. Each data line may form parasitic capacitance Cdp of a specific level with a pixel electrode that it overlaps. For example, second data line DL2 may form parasitic capacitance with second pixel electrode P2 by overlapping second area a2 of second pixel electrode P2. Second data line DL2 may form parasitic capacitance with first pixel electrode P1 by overlapping third area a3 of first pixel electrode P1. From the perspective view of pixel electrodes, second area a2 of first pixel electrode P1 may overlap first data line DL1, and third area a3 of first pixel electrode P1 may overlap second data line DL2. First pixel electrode P1 may form parasitic capacitance with first data line DL1 through second area a2 and form parasitic capacitance with second data line DL2 through third area a3.

Second data line DL2 may be separated by a predetermined distance a from the boundary area between first pixel electrode P1 and second pixel electrode P2. The predetermined distance “a” may be a maximum error distance set in view of the possible misalignment of a data line. Even if second data line DL2 is misaligned, it may still form parasitic capacitance with second pixel electrode P2 by overlapping second area a2 of second pixel electrode P2 and may form parasitic capacitance with first pixel electrode P1 by overlapping third area a3 of first pixel electrode P1.

Referring to FIG. 12, second data line DL2 may be separated in first direction D1 from the boundary area between first pixel electrode P1 and second pixel electrode P2 by the predetermined distance “a” to overlap second area a2 of first pixel electrode P1. Second data line DL2 may form parasitic capacitance Cdp1 of a specific level with second area a2 of first pixel electrode P1. Referring to FIG. 13, even when second data line DL2 is misaligned, by being shifted in the first direction D1, it may still overlap first pixel electrode P1. Since entire second data line DL2 still overlaps first pixel electrode P1, a vertical distance between second data line DL2 and first pixel electrode P1 may be maintained at a constant distance despite misalignment. Accordingly, parasitic capacitance Cdp1 between second data line DL2 and first pixel electrode P1 may not substantially change.

Referring to FIG. 14, second data line DL2 may be separated in a reverse direction of first direction D1 from the boundary area between first pixel electrode P1 and second pixel electrode P2 by the predetermined distance “a” to overlap third area a3 of second pixel electrode P2. Second data line DL2 may form parasitic capacitance Cdp2 of a specific level with third area a3 of second pixel electrode P2. Referring to FIG. 15, even when second data line DL2 is misaligned, by being shifted in the reverse direction of the first direction D1, it may still overlap second pixel electrode P2. Since entire second data line DL2 still overlaps second pixel electrode P2, a vertical distance between second data line DL2 and second pixel electrode P2 may be maintained at a constant distance despite misalignment. Accordingly, parasitic capacitance Cdp2 between second data line DL2 and second pixel electrode P2 may not substantially change.

Parasitic capacitance formed by a pixel electrode and a data line according to one or more exemplary embodiments may have a constant value despite the misalignment of the data line. Accordingly, even if the 2-dot inversion method is used, there may be no substantial change in the parasitic capacitance in an inversion unit. This may prevent or reduce a horizontal line defect, thus providing a more improved display quality.

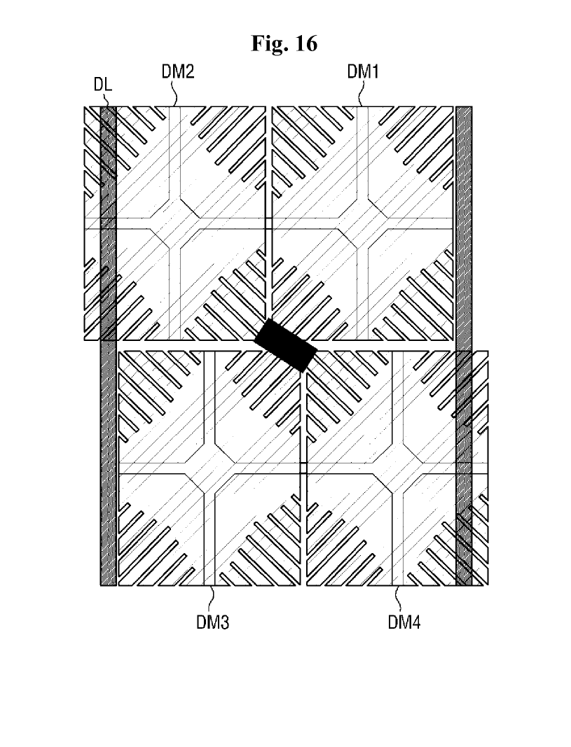

FIG. 16 is a plan view of a pixel of an LCD according to one or more exemplary embodiments.

Referring to FIG. 16, the pixel of the LCD according to one or more exemplary embodiments may be divided into a plurality of domains. The domains may be four domains, and liquid crystals in the domains may rotate in a counterclockwise direction, but aspects of the present invention are not limited thereto. Domains disposed or formed in different row directions may be shifted. Form example, first domain DM1 and second domain DM2 as well as third domain DM3 and fourth domain DM4 may be shifted in first direction D1. A data line extending along second direction D2 may not continuously overlap domains formed or disposed side by side along second direction D2. For example, one data line may overlap second domain DM2 but may not overlap third domain DM3 formed or disposed side by side with second domain DM2 along second direction D2. Another data line neighboring the data line may not overlap first domain DM1 but may overlap fourth domain DM4 formed or disposed side by side with first domain DM1 along second direction D2. Domains overlapped by data lines may be diagonally symmetrical to each other. This can reduce or minimize a change in a domain ratio due to an overlap between a data line and a pixel electrode.

Other components of LCD 20 are substantially identical to those of LCD 10 of FIGS. 1 through 7 identified by the same names, and thus, a detailed description thereof is omitted.

One or more exemplary embodiments may reduce or prevent a horizontal line defect caused by parasitic capacitance (Cdp), and may provide a more improved display quality.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A liquid crystal display (LCD) comprising:
a first pixel electrode portion;
a second pixel electrode portion disposed adjacent to the first pixel electrode portion in a first direction; and
a first data line, extending substantially in a second direction, configured to apply a data voltage to the first pixel electrode portion;
wherein the first data line comprises a first line portion overlapping the first pixel electrode portion and a second line portion overlapping the second pixel electrode portion.

2. The LCD of claim 1, further comprising:
a second data line, extending substantially in the second direction, configured to apply a data voltage to the second pixel electrode portion; and
a control circuit configured to apply data voltages to the first and second data lines,
wherein data voltages to be applied to the first pixel electrode portion and the second pixel electrode portion are of different polarities.

3. The LCD of claim 1, wherein the first line portion is separated from a boundary area between the first pixel electrode portion and the second pixel electrode portion by a distance, and
the second line portion is separated from the boundary area between the first pixel electrode portion and the second pixel electrode portion by a distance.

4. The LCD of claim 3, wherein the first line portion is separated from the boundary area between the first pixel electrode portion and the second pixel electrode portion by a distance at which the first line portion does not form a substantial amount of parasitic capacitance with the second pixel electrode, and
the second line portion is separated from the boundary area between the first pixel electrode and the second pixel electrode by a distance at which the second line portion does not form a substantial amount of parasitic capacitance with the first pixel electrode.

5. The LCD of claim 1, wherein the first data line further comprises a third line portion extending substantially in the first direction and connecting the first line portion and the second line portion.

6. The LCD of claim 5, wherein the third line portion extends along a virtual line bisecting at least one of a side of the first pixel electrode portion and a side of the second pixel electrode portion.

7. The LCD of claim 6, wherein the first line portion substantially overlaps a half of the first pixel electrode portion relative to the virtual line, and the second line portion substantially overlaps an opposite half of the second pixel electrode relative to the virtual line.

8. The LCD of claim 3, further comprising a storage line extending along the boundary area between the first pixel electrode and the second pixel electrode.

9. The LCD of claim 8, wherein a cross-sectional dimension of the storage line is substantially equal to that of a cross-sectional dimension of the boundary area.

10. A liquid crystal display (LCD) comprising:
a first pixel electrode portion;
a first data line, extending substantially in a first direction, configured to apply a data voltage to the first pixel electrode portion; and
a second data line, extending substantially in a first direction, disposed adjacent to the first data line in a second direction,
wherein a portion of the first data line overlaps the first pixel electrode portion along a side area of the first pixel electrode portion, and a portion of the second data line overlaps the first pixel electrode along an opposite side area of the first pixel electrode.

11. The LCD of claim 10, further comprising:
a second pixel electrode portion disposed adjacent to the first pixel electrode portion in the second direction, wherein the second data line is configured to apply a data voltage to the second pixel electrode portion; and
a control circuit to apply data voltages of opposite polarities to the first and second data lines.

12. The LCD of claim 11, further comprising a storage line which extends along a boundary area between the first pixel electrode portion and the second pixel electrode portion.

13. The LCD of claim 10, wherein the first pixel electrode portion comprises a first subpixel electrode and a second subpixel electrode being charged with data voltages of different levels.

14. The LCD of claim 10, wherein the first pixel electrode portion is divided into a plurality of domains and comprises a first subpixel electrode and a second subpixel electrode being charged with data voltages of different levels.

15. The LCD of claim 10, wherein the first and second side areas of the first pixel electrode are bisected by a virtual line, the first data line portion overlapping a lower part of the first side area of the first pixel electrode portion, and the second data line portion overlapping an upper part of the second side area of the first pixel electrode portion.

16. A liquid crystal display (LCD) comprising:
a first pixel electrode portion;
a second electrode portion disposed adjacent to the first pixel electrode along a first direction; and
a first data line extending along a second direction substantially perpendicular to the first direction,
wherein the first data line overlaps the first pixel electrode portion and the second pixel electrode portion.

17. The LCD of claim 16, wherein the first pixel electrode portion comprise a first area, a second area protruding from a first side of the first area in a direction along the first direction, and a third area protruding in an opposite direction from a second side of the first area,
wherein the second pixel electrode portion comprises a fourth area, a fifth area protruding from a first side of the fourth area in a direction along the first direction, and a sixth area protruding in an opposite direction from a second side of the fourth area, and
wherein the first data line overlaps the third area of the first pixel electrode portion and the fourth area of the second pixel electrode.

18. The LCD of claim 17, wherein the second area and the third area do not overlap one other along the first direction.

19. The LCD of claim 16, wherein the first data line is separated from a boundary area between the first pixel electrode portion and the second pixel electrode portion by a distance to overlap the first pixel electrode and the second pixel electrode.

20. The LCD of claim 16, further comprising a storage line which extends along a boundary area between the first pixel electrode and the second pixel electrode.
